(19) United States
(12) Patent Application Publication
(10) Pub. No.: US 2012/0109762 A1
(43) Pub. Date: May 3, 2012

(54) METHOD AND APPARATUS FOR PROVIDING MOBILE PAYMENT THROUGH A DEVICE USER INTERFACE

(75) Inventor: Jeffrey M. Getchius, Cambridge, MA (US)

(73) Assignee: VERIZON PATENT AND LICENSING INC., Basking Ridge, NJ (US)

(21) Appl. No.: 12/938,661

(22) Filed: Nov. 3, 2010

(51) Int. Cl. G06Q 20/00

(52) U.S. Cl. 705/17; 235/375

(57) ABSTRACT

An approach is provided for facilitating the purchase of items at a point-of-sales terminal based on barcode information presented by a wireless communication device. Barcode information is received at a point-of-sales terminal as obtained from a wireless communication device. A message in response to the received barcode information is generated for transmission to the wireless communication device to permit acknowledgement of the purchase transaction by a user of the wireless communication device.

### BACKGROUND INFORMATION

The current trend for most consumers when purchasing goods or services from a merchant is to facilitate the purchase through use of a credit card, debit card or the like. While such payment mediums provide consumers with a convenient alternative to cash, they are not without their requisite risk. In particular, credit cards lend themselves to security and authority risks, namely in the form of identity fraud, credit card fraud and unwarranted purchase transaction usage. While there are various measures intended to address the issue of security and authorization, the most common protocol for enabling consumer purchases via a credit or debit card is through human (e.g., cashier) observation of purchaser identification (e.g., a driver's license) in addition to signatory authorization of purchases. Ultimately, these and any other measures relating to electronic payment processing aim verify the actual presence of the consumer during the moment of a purchase transaction. Without properly verifying the presence of the consumer at the point and time of the purchase transaction, virtually anyone can utilize the consumer's credit and/or debit card to make purchases.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of facilitating a transaction at a point-of-sales terminal through use of a barcode image acquired from a wireless communication device, in accordance with an exemplary embodiment;

FIG. 2 is a diagram of a wireless communication device configured to acquire a barcode image to facilitate a transaction at a point-of-sales terminal, in accordance with an exemplary embodiment;

FIGS. 3A and 3B are diagrams of a graphical user interface (GUI) of a wireless communication device configured to facilitate a transaction at a point-of-sales terminal, according to various embodiments;

FIGS. 4A and 4B are flowcharts of a process for facilitating a transaction at a point-of-sales terminal through use of a barcode image acquired from a wireless communication device, according to various embodiments;

FIG. 5 is a diagram of the interaction between a wireless communication device and a point-of-sales terminal to facilitate a transaction through use of a barcode image, in accordance with an exemplary embodiment;

FIG. 6 is a diagram of the interaction between a wireless communication device and a point-of-sales terminal involving a transaction verification process, in accordance with an exemplary embodiment;

FIGS. 7A and 7B are diagrams of a graphical user interface (GUI) of a wireless communication device configured to facilitate a transaction at a point-of-sales terminal through use of a barcode image, according to an exemplary embodiment;

FIG. 8 is a diagram of a computer system that can be used to implement various exemplary embodiments; and

FIG. 9 is a diagram of a chip set that can be used to implement various exemplary embodiments.

### DESCRIPTION OF THE PREFERRED EMBODIMENT

A preferred apparatus, method, and software for facilitating the purchase of items at a point-of-sales terminal based on barcode information presented by a wireless communication device is described. In the following description, for the purposes of explanation, numerous specific details are set forth to provide a thorough understanding of the preferred embodiments of the invention. It is apparent, however, that the preferred embodiments may be practiced without these specific details or with an equivalent arrangement. In other instances, well-known structures and devices are shown in block diagram form to avoid unnecessarily obscuring the preferred embodiments of the invention.

Although various exemplary embodiments are described with respect to a point-of-sales (POS) terminal, it is contemplated that these embodiments have applicability to any device capable of processing a financial transaction.

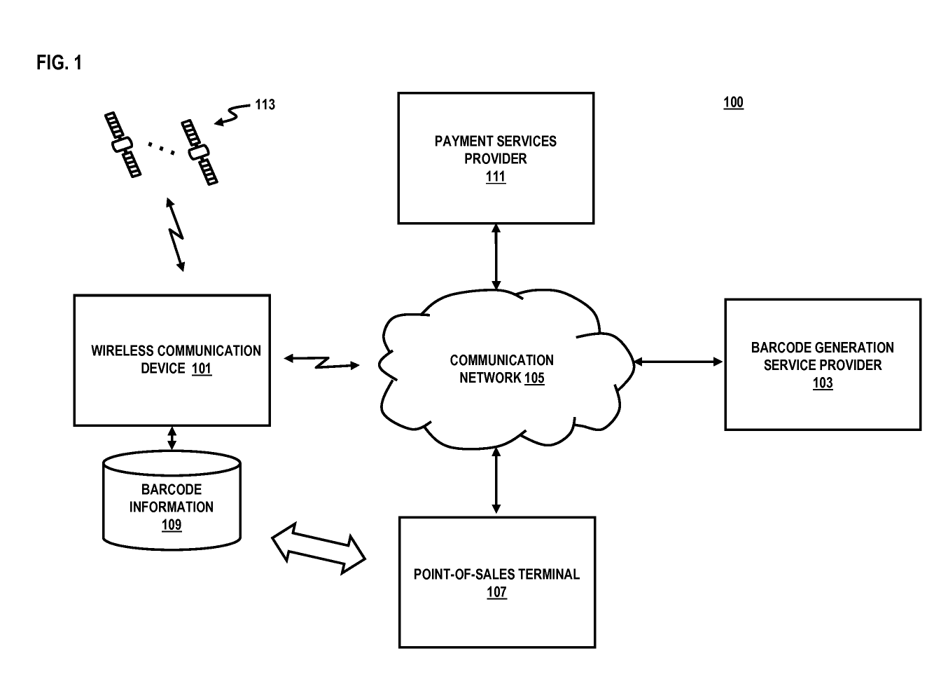

FIG. 1 is a diagram of a system for facilitating a transaction at a point-of-sales (POS) terminal based on barcode information presented by a wireless communication device, according to an exemplary embodiment. For the purposes of illustration, system 100 enables purchase of items at a point-of-sales terminal based on barcode information presented by a wireless communication device 101. According to one embodiment, the barcode information is acquired from a barcode generation service provider 103. System 100 includes a communication network 105 to provide connectivity for one or more point-of-sales (POS) terminals 107, which may be distributed over a range of geographical locations. In certain embodiments, wireless device 101 retains barcode information within data store 109, which may be local memory or a removal storage device. In effect, system 100 supports mobile payment transactions through the use of barcode information displayed on device 101.

In various embodiments, the barcode information is associated with a payment transaction at the time of customer checkout at POS terminal 107. The barcode information is further associated with the payment transaction during a payment transaction acknowledgement process that occurs between the wireless communication device 101 and the POS terminal 107. As will be discussed further, the exemplary process detailed herein provides an additional means of payment or purchase authorization, sufficient to enable a more secure and seamless payment transaction to be fulfilled. By way of example, a payment transaction pertains to any means in which payment is facilitated during an engagement process between a customer desiring to purchase and acquire certain goods and/or services and a seller of the goods and/or services. In general, the payment transaction entails presentment of the means of payment, validation of the means of payment, acceptance of the means of payment, authorization of use of the means of payment, etc. A particularly popular medium for facilitating payment transactions is by way of credit cards, debit cards or the like.

A central security feature for most credit card based payment transactions, aside from the account validation process, is signature verification. Signature verification occurs when an operator of the point-of-sales terminal performs the following: (1) the operator requests that the purchaser sign a payment transaction receipt as generated in response to credit card account validation, (2) the operator then manually inspects the signature and confirms whether it matches with a signature affixed to the backside of the credit card, (3) alternatively or in addition to the manual inspection and match confirmation, the operator requests that a picture based identification (ID), e.g., drivers license, of the purchaser be provided so that they may visually validate that the purchaser of the good and/or service matches the provided credit card. Any ambiguity detected by the operator in the performance of any of these steps should be flagged, result in revocation of the payment transaction or even result in denial of the entire purchase process with the credit card and/or debit card. Unfortunately, however, this process is not always executed on the part of the operator in the manner presented above. Even still, when performed as described, a forged signature, fake identification or other fraudulent activity is sufficient enough to circumvent the security process.

Even debit cards, which require that the user enter a personal identification number (PIN) or security code as a means of validating and/or further authorizing a payment transaction, are not without risk. As no signatory requirement is necessary to facilitate payment transactions by way of a debit card, an unauthorized user need only know the PIN number or security code of the authentic debit card owner. In both the case of the credit card and the debit card, no additional layer or means of security, authorization, validation or acknowledgement is afforded to prevent fraudulent execution of payment transactions—i.e., payment transactions facilitated without the express permission or awareness of the credit card or debit card owner.

To address this problem, system 100, according to certain embodiments, provides an approach for facilitating the purchase authorization and/or payment transaction process on the basis of a barcode associated with the purchase transaction. The barcode is generated and/or provided by a barcode generation service provider, and made available for presentment by the wireless communication device 101 to a point-of-sales terminal 107. As will be discussed further, detection of the barcode at the point-of-sales terminal 107 during the moment of a purchase transaction, by way of the user's wireless communication device 101, enables commencement of the payment transaction process. It is particularly noted that the system 100 affords a means of validation of the physical presence and authority of the user at the point-of-sales terminal 107 respective to an acknowledgement of the payment transaction, thereby ensuring a further level of security and protection for a consumer.

In one embodiment, POS terminal 107 is a computerized device for conducting a financial or payment transaction. POS terminal 107 can include, for example, functions for recording and tracking customer orders, processing credit and debit cards (e.g., featuring built-in payment acceptance and processing systems) and managing inventory and deliveries. In addition, POS terminal 107 can connect to other systems and devices over the communication network 105, including those systems and devices directly within the environment of its operation (e.g., other POS systems or computers within the store location) as well as external systems. To enable such functionality, the POS terminal 107 can be configured with a personal computer as a core processor and/or facilitator for enabling an operator to engage in sales or purchase transactions with customers. As such, the computer is provided with application-specific programs and I/O devices for the particular environment or industry which it serves. For example, a POS terminal 107 customized for a restaurant may feature interface and design elements that enable the operator to access information regarding all items on the menu, seating assignments, etc. The operator may query a database containing menu data directly from the terminal on demand. General environments or industries for the use of POS terminals 107 may include any wherein a point-of-sale interaction between a customer and goods or service provider is necessary, including but not limited to, a service desk, a checkout area, a registration booth, an order placement kiosk, etc. In some instances, a virtual POS terminal may also be configured for enabling web-based purchase transactions and the like.

In one embodiment, the POS terminal 107 communicates with the wireless communication device 101 and other devices configured to the communication network 105 via known messaging techniques, including text and email. As such, the POS terminal 107 is configured with a messaging module (not shown) or other means for generating of messages in response to purchase transactions, orders, invoices, goods, services, etc. In this way, the POS terminal 107 can be programmed to trigger the generation and transmission of messages to a wireless communication device belonging to the purchaser at some point during the purchase transaction process.

As shown, in one embodiment, a payment services provider 111 may also interact with the POS terminal 107, by way of communication network 105, to enable debit, prepaid and/or credit card purchase transactions to be performed when necessary. Exemplary payment services providers/companies may include credit card services company. In general, these providers maintain a payment processing technology infrastructure for facilitating payment transactions through use of digital currency as opposed to cash or checks. As such, a given payment services providers connect consumers, businesses, financial institutions, government agencies, etc. accordingly to respective financial institutions and merchants for appropriating, reconciling and seamlessly managing payment.

Under the scenario of FIG. 1, POS terminal 107 accesses payment services provider 111 over the communication network 105 through known interface mediums. For the purpose of enabling credit, debit or prepaid card payments directly via the POS terminal 107, the interface means is enabled by way of an integrated or peripherally coupled credit card reader, account entry system, debit card code and authorization device or the like. These systems are programmed to convey the information as encoded on the magnetic strip of the card, including but not limited to, the account information, registered card holder, security code detail, etc. As part of the communication process between the POS terminal 107 and the payment services provider 111, protocols are also employed for verifying the validity of the associated account, verifying funds availability, finalizing and validating transactional credits/debits between the payment services provider and the owner of the POS terminal 107, etc.

In one embodiment, the barcode generation services provider generates barcodes of various types, which may be provided to a requesting application operable by the wireless communication device 101. Regardless of type, the barcode is any type that is readable by a scanning device or barcode reader of the POS terminal 107. Depending on the size and/or density of the barcode—i.e., number of bytes of data enabled by the barcode—various details associated with the wireless communication device may be encoded within. This may include, but is not limited to, the phone number associated with the wireless communication device 101, name of the registered owner of the wireless communication device, email address of the owner, Short Messaging Service (SMS) handle for the device, device identification or serial number information, etc.

Barcodes are accessed, when required, from the barcode generation services provider 103 based on a subscription or permission basis. Hence, a requesting application—i.e., an application of the wireless communication device 101—directly calls to the barcode generation service provider 103 on a subscription or permission basis at the time of need to download one or more barcodes. An exemplary moment of need may be during the time of purchase transaction, wherein a unique barcode is supplied in relation to the wireless device relative to a specific transaction. In this arrangement, a different barcode is provided on a per transaction basis, so as to ensure a persistent means of adapting the means of purchase authorization or security. It is noted that this approach creates an additional security layer respective to a purchase transaction as the barcode is customized to a specific purchase transaction. In addition, the user of the wireless communication device 101 is also required to login to the barcode generation service provider 103 at the time of purchase—yet another step in the purchase transaction authorization process.

According to one embodiment, barcodes are stored to data store 109 of the wireless communication device 101 at a certain periodicity for immediate or subsequent use by the requesting application when needed. As yet another alternative, a single barcode may be associated with and stored to the wireless communication device for repeated use in the engagement of purchase transactions, such as when the device 101 is programmed and/or loaded with its essential software applications and features. In this case, the device manufacturer may register the unique barcode in association with the device identification number, serial number, registration number or other identifier unique to that device. This process may also occur on a one-time basis at a later point of device 101 operation, such as when the device is first registered with the barcode generation service provider. Indeed, any means by which a barcode may be associated with a specific wireless communication device 101 for the purpose of facilitating a purchase transaction is within the scope of the exemplary techniques and concepts presented herein. Furthermore, it is contemplated that the provider of the barcode is the device manufacturer directly, wherein no particular subscription process or interaction is required.

System 100 operate in concert to enable to support a means of interaction suitable for enabling purchase transactions to commence at the POS terminal 107 in connection with a wireless communication device 101. Furthermore, all of the above described elements of the system 100 are communicable with one another over communication network 105. In system 100, according to certain embodiments, communication network 105 may be one or more of a combination of a data network, service provider network, telephony network, and/or wireless network, configured to handle various communication sessions, voice communications as well as non-voice communications. Communication network 105 may be any suitable wireline and/or wireless network. In the example of a telephony network, communication network 105 may include a circuit-switched network, such as the public switched telephone network (PSTN), an integrated services digital network (ISDN), a private branch exchange (PBX), or other like network.

Communication network 105 can also include wireless systems that may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), long term evolution (LTE), satellite, and the like. Also, communication network 105 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Still further, the communication network 105 may embody circuit-switched and/or packet-switched networks that include facilities to provide for transport of circuit-switched and/or packet-based communications. It is further contemplated that the communication network 105 includes components and facilities to provide for signaling and/or bearer communications between the various components or facilities of system 100. In this manner, the network 105 may embody or include portions of a signaling system 7 (SS7) network, or other suitable infrastructure to support control and signaling functions. As such, network 105 may be adapted to facilitate the purchase transaction enablement services of system 100.

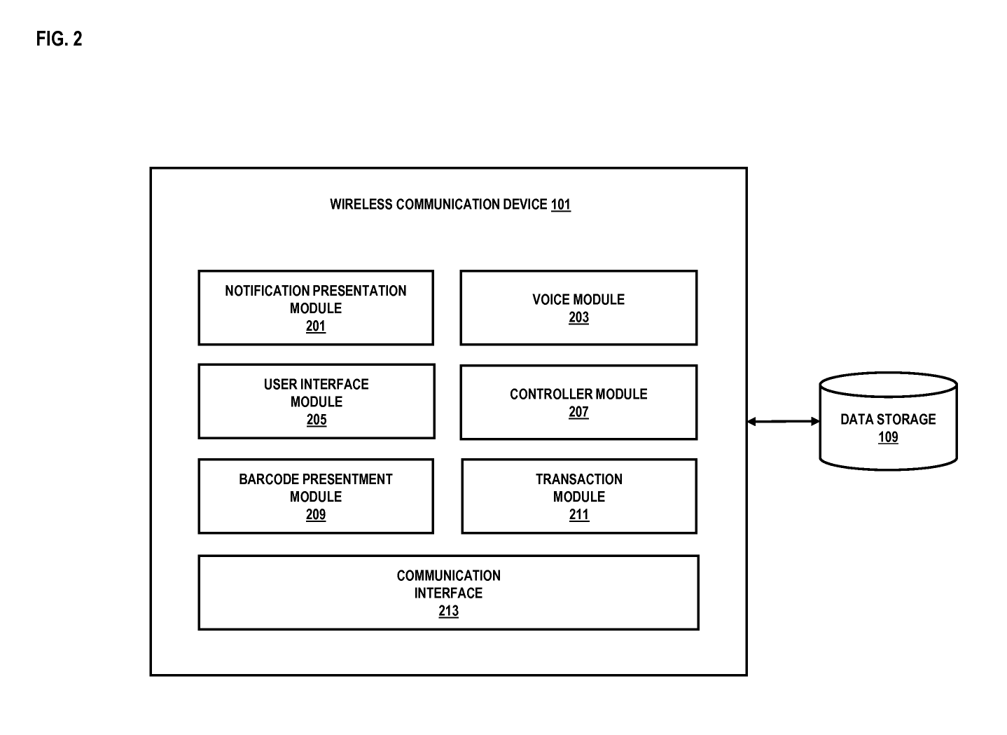

While the various embodiments discussed herein pertain to the enablement of purchase transactions based in part on the use of barcode information, the principles apply to any type of wireless communication device through which data may be received or relayed. Wireless communication devices may include, but is not limited to, mobile devices (e.g., cellular phones, BLUETOOTH-enabled devices, WiFi-enable devices, etc.), a set-top box (STB), a computer 101 (e.g., desktop computer, laptop, web appliance, netbook, iPad, etc.) and voice station. Regardless of type, generally, wireless communication devices are configured to communicate over the wireless communication network 105 using voice sessions as well as other non-voice sessions, e.g., short messaging service (SMS), enhanced messaging service (EMS), multimedia messaging service (MMS), instant messaging (IM), etc. Also, the devices may convey geographical or spatial information with a constellation of global positioning system (GPS) satellites 113, such as to enable location detection, by way of example. Wireless communication devices may be any cellular phone, radiophone, satellite phone, smart phone, wireless phone or any other suitable mobile device, such as a personal digital assistant (PDA), pocket personal computer, tablet, customized hardware, etc. More regarding the specific configuration of a wireless communication device for enabling the acquisition and presentment of barcode information and/or to facilitate payment processing respective to a purchase transaction is presented in greater detail in FIG. 2.

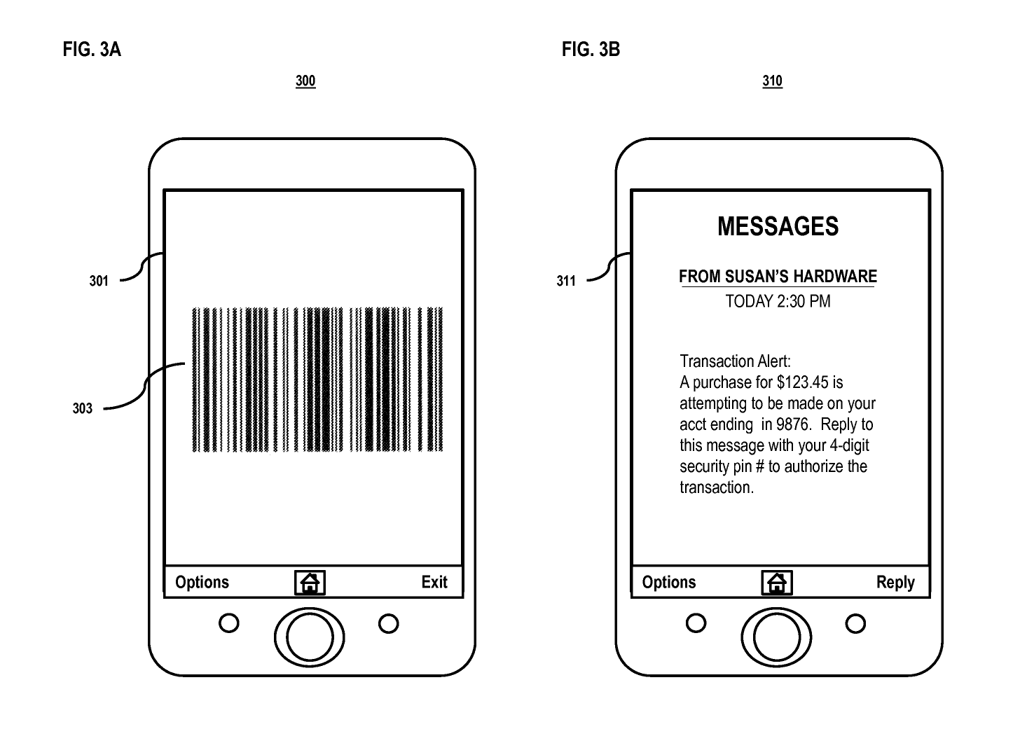

FIG. 2 is a diagram of a wireless communication device configured to acquire a barcode image to facilitate a purchase transaction at a point-of-sales terminal, in accordance with an exemplary embodiment. In certain embodiments, wireless communication device 101, which may be a mobile phone (as depicted in FIGS. 3A and 3B), mobile computer, etc., includes the following components: a notification presentation module 201, a voice module 203, a user interface module 205, a controller module 207, a barcode presentment module 209, a transaction module 211, and a communication interface 213. It is contemplated that the functions of these components may be combined in one or more components or performed by other components of equivalent functionality.

Notification presentation module 201 supports text based communication—i.e., present and create text-based notification messages. Voice module 203 is configured to establish a voice-based call. Such voice-based calls can be traditional plain-old-telephone service (POTS) calls or packetized voice calls (e.g., VoIP). It is noted that these communication sessions can be established over a circuit-switched network, a packet-switch network, or a combination thereof. Thus, communication interface 213 can be appropriately configured depending on the transport systems and/or communication network 105 elements involved.

User interface module 205 enables the presentment of data to a graphical user interface of the wireless communication device 101. Various software applications operable by the wireless communication device may feature APIs or other function calls corresponding to the user interface module 205 for enabling graphical elements to be displayed by the device. It is noted that in some instances multiple communication interfaces may be utilized depending on the type of wireless communication device involved. Moreover, wireless communication device 101 employs the user interface module 205 to enable control by the user of the device 101 of various communication features during a session.

Controller module 207 coordinates the concurrent communication sessions provided by the notification presentation module 201 and voice module 203. For example, the controller module 207 generates the appropriate signals to control the communication interface 213 for transmission over the voice channel and the messaging channel.

The barcode presentment module 209 enables barcodes to be presented to the user interface of the wireless communication device 101 in conjunction with the user interface module 205.

FIG. 3A is an exemplary depiction of a mobile device 300, as configured with respect to the modules of FIG. 2, that features a graphical user interface 301 through which barcode data 305 may be presented, in accordance with one embodiment. Barcode presentment module 209 enables the wireless communication device 300 to serve as a means of relaying barcode information to POS terminal 107 in the context of a purchase transaction. Specifically, barcode presentment module 209 operates in connection with the graphical user interface module 205 such that the barcode is of a quality suitable for enabling its reading and/or interpretation by scanning devices at the POS terminal 107. In addition to rendering barcodes to a user interface 303, barcode presentment module 209 can communicate with the barcode generation services provider 103 by way of direct application request, function call, client/server interaction, etc. to acquire and subsequently store barcodes to data storage 109 of the device 300.

Transaction module 211 enables purchase transactions to be carried out in relation to a received message conveying transactional detail information. Transactional detail information may include, for instance, barcode information, items associated with the purchase, purchase amount, location of the POS terminal 107 or owner of record of the POS terminal 107, user instructions, etc. In certain embodiments, the received message may be a text message or e-mail as conveyed by notification presentation module 201 in response to an attempted purchase transaction at a POS terminal 107. FIG. 3B is an exemplary depiction of a mobile device 310 having a user interface 311 through which transactional detail information may be presented, according with one embodiment. In this example, the message is a transaction alert intended to alert the user of the mobile device 310 of an attempted purchase against a credit or debit card ending in 9876 (e.g., last 4 digits) in the amount of $123.45 from Susan's Hardware. According to one embodiment, the message also indicates instructions for the user to follow to authorize the purchase transaction.

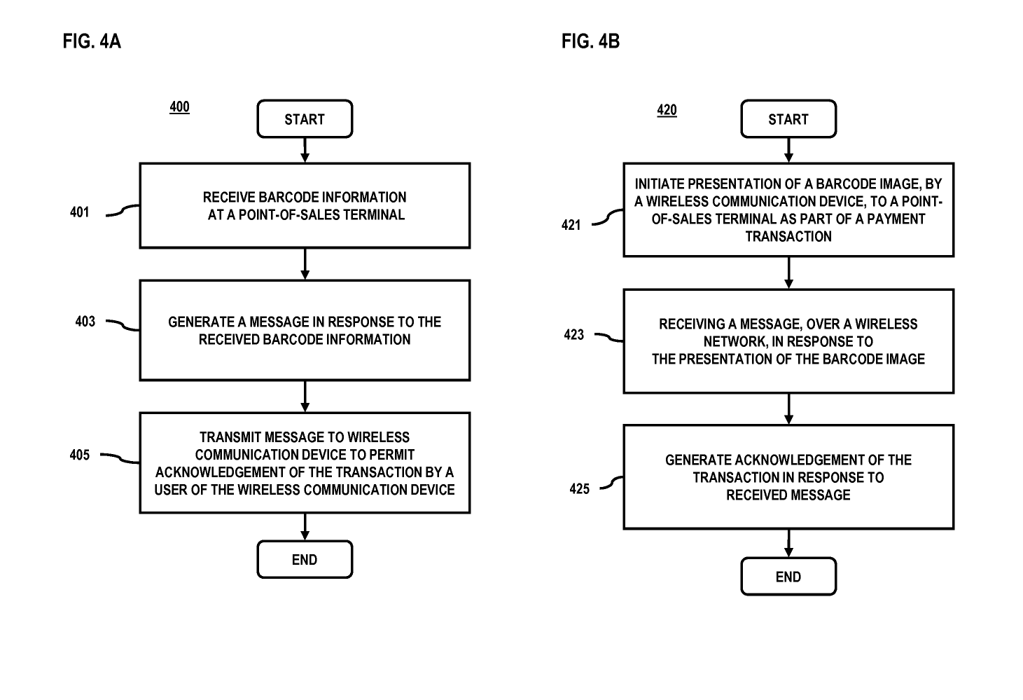

FIGS. 4A and 4B are flowcharts of a process for facilitating a transaction at a point-of-sales terminal through use of a barcode image acquired from a wireless communication device, according to various embodiments. With reference to FIG. 4A, a purchase transaction process 400 is described from the perspective of a POS terminal 107. In step 401, barcode information is received from a POS terminal 107. In this case, the barcode information is obtained from the scanning of a barcode image as obtained from wireless communication device 101, i.e., as shown with respect to FIG. 3A. Next, a message is generated in response to the received barcode information (per step 403) and transmitted to the wireless communication device 101 to permit acknowledgement of the transaction by a user of wireless communication device 101 (step 405). By way of example, the message may be generated by the POS terminal 107 in a manner shown with respect to FIG. 3B.

FIG. 4B shows a transaction process 420 from the perspective of a wireless communication device. In step 421, the process initiates presentation of a barcode image to POS terminal 107 as part of a payment transaction, as shown with respect to FIG. 3A. In certain embodiments, this initiating step is performed by wireless communication device 101. In step 423, a message is received over a wireless network (e.g., a cellular network within communication network 105) in response to the presentation of the barcode image. The message requests acknowledgement of the transaction by a user of the wireless communication device 101. Upon receiving input by the user (according to one embodiment), an acknowledgement message is generated by wireless communication device 101, as in step 425. The acknowledgement message is then transmitted.

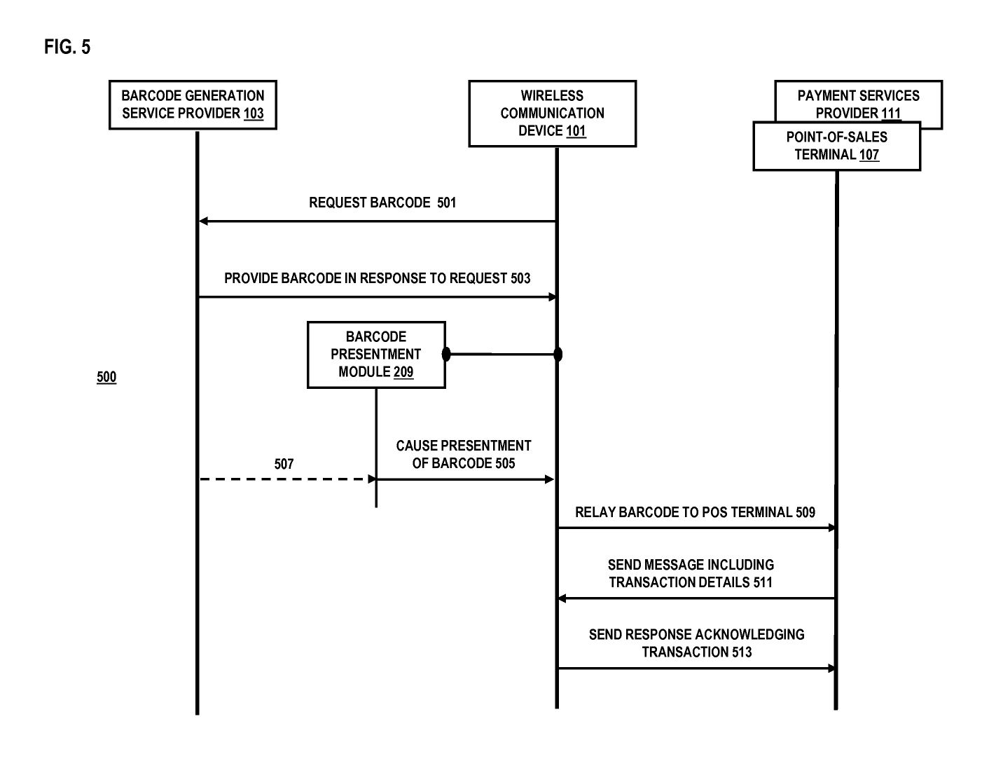

FIG. 5 is a diagram of the interaction that occurs between a wireless communication device and a point-of-sales terminal to facilitate a purchase transaction through use of a barcode image, in accordance with an exemplary embodiment. By way of example, process 500 involves communications between POS terminal 107 and payment services provider 111 relating to purchase transactions by wireless communication device 101. In step 501, wireless communication device 101 requests a barcode (or barcode information) that is to be presented to the POS terminal 107 in relation to a user's attempt to enable a purchase transaction. As stated previously, the barcode is provided to wireless communication device 101 as it is recalled from memory of device 101 or provided by the barcode generation service provider 103 (per step 503). In step 505, the barcode is then caused to be rendered to the display of the wireless communication device 101, such as through operation of the barcode presentment module 209 and/or the user interface module (not shown) of the device 101. Alternatively, it is contemplated that the barcode is caused to be rendered to the display of the wireless communication device 101 directly by the barcode generation service provider 103, as in step 505.

Once presentment of the barcode is executed via the display of the device 101, device 101 relays, as in step 509, the barcode to the POS terminal 107 that is being utilized to facilitate the purchase transaction. In particular, the barcode (as shown to the screen) is scanned by a barcode reader or other scanning device of the POS terminal 107, wherein the barcode data is decoded and processed accordingly. Processing on the part of the POS terminal 107 may be performed in association with the related payment services provider 111 (corresponding to the particular credit card, debit card or prepaid card provided by the purchaser during the attempted purchase transaction).

In addition to the described data exchange that occurs between POS terminal 107 and payment services provider 111 via an established payment processing infrastructure, payment services provider 111 may also execute certain user defined security or purchase transaction enablement protocols respective to system 100. One such protocol may require establishment of a user/cardholder defined purchase transaction security code; e.g., this code can be separate from the established PIN, online access code, etc. The user can create this code with payment services provider 111 solely for purchase transactions to be enabled via wireless communication device 101. Under this arrangement, the credit card, debit card or prepaid card allows finalization of a payment transaction upon entry of this code by the user from the designated wireless communication device. It is noted that such an arrangement creates an additional layer of security for the user in purchase transaction processing situations, and in addition, makes wireless communication device 101 a central requirement for fulfillment of the transaction.

Another protocol may be utilized for establishment of a user/cardholder defined agreement to enable purchase transactions via a wireless communication device. In accordance with this protocol, the user expressly enables payment for goods and/or services by way of the security and/or purchase transaction fulfillment mechanisms. This option may be enabled or disabled at the discretion of the cardholder with the payment services provider 111, such as in accordance with an enrollment process, subscription process or the like. Deactivation (or disablement) of the option eliminates the requirement for acknowledgement and/or use of a wireless communication device 101 to fulfill a purchase transaction. The user may benefit from enabling or disabling the option as needed for the particular purposes. For example, the user may choose to activate this option as a way to monitor the activity of additional credit cards associated with a single account, whereby the additional cards are under the control of their dependents (e.g., children). In this case, the primary cardholder and owner of the corresponding wireless communication device 101 would be sent, according to one embodiment, a text alert of all purchase transactions and the associated costs. Only through acknowledgement and hence, authorization of the purchase transaction via the cardholder's wireless communication device, and not that of the dependent, could the transaction be conducted successfully. Alternatively, the user may disable the mobile device enabled purchase transaction fulfillment option in instances where the user knows in advance that certain transactions will be performed.

Furthermore, a user defined device registration protocol can be utilized. In such a case, the user specifies a particular wireless communication device, phone number of the device, a preferred messaging scheme (e.g., text, email, and/or instant messaging (IM)), etc. to be employed in accordance with the exemplary methods and techniques described herein. This preference information may be shared with the POS terminal 107 involved in a purchase transaction to facilitate communication, according to one embodiment.

At this point in the interactive process 500, the barcode is now associated with the wireless communication device 101, and the purchase transaction can proceed—i.e., barcode is now referenced to the specific goods attempting to be purchased, the billing amount, etc. In certain instances, POS terminal 107 may be programmed to provide printing of the barcode to the final receipt executed upon completion of the purchase transaction. In step 511, in response to the barcode being scanned, POS terminal 107 generates and sends a message featuring the transaction information details to wireless communication device 101 from which the barcode was detected. For example, the message may be generated and sent to the device 101 in the manner as depicted with respect to FIG. 3B. It is noted that the text is directed by POS terminal 107 to the very same device 101 in which the barcode was scanned. As such, upon receipt of the text, the operator of POS terminal 107 would have an opportunity to observe that the user device 101 receiving the message is indeed the same as the user device 101 associated with the purchase transaction being engaged at the moment.

Upon receipt of the message to the wireless communication device 101, device 101 sends an acknowledgement of the message regarding the purchase transaction, per step 513. Acknowledgement may be indicated and processed in various ways, including but not limited to, the user sending a response message indicating a predetermined security code that may be extrapolated and processed by POS terminal 107 and/or payment services provider 111; the user sending a response message indicating a “yes” or “no” to the purchase transaction as indicated; or the user forwarding the received message back to the originating POS terminal 107, etc. The acknowledgement is received by the POS terminal 107 and conveyed to the payment services provider 111, indicating user/cardholder authorization to proceed with the purchase transaction.

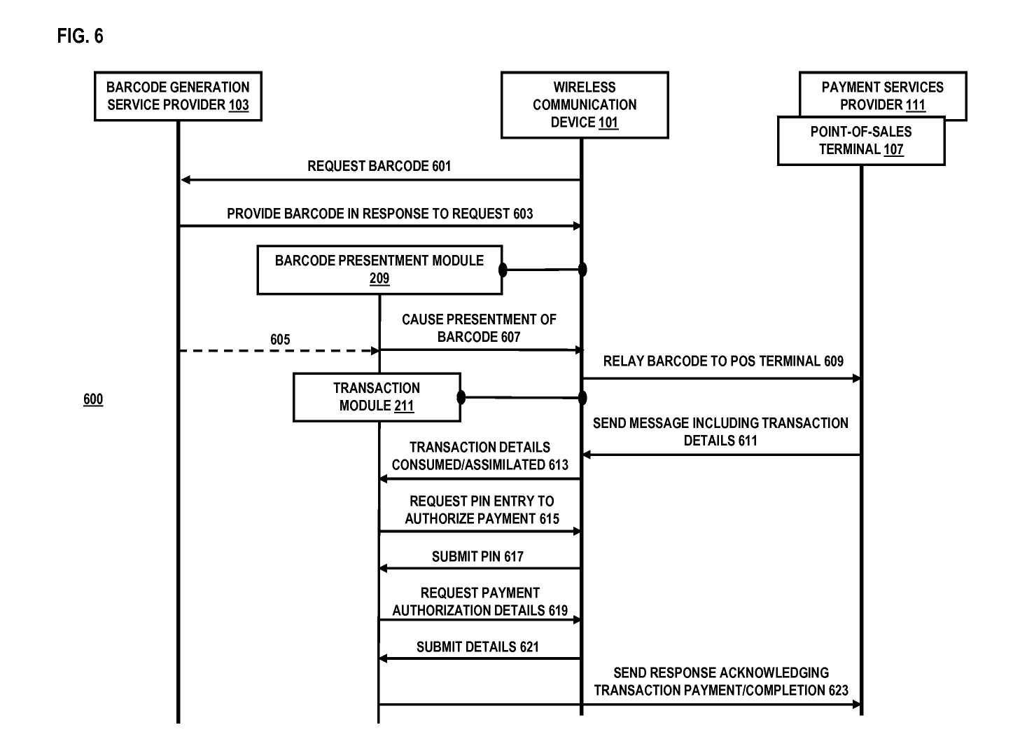

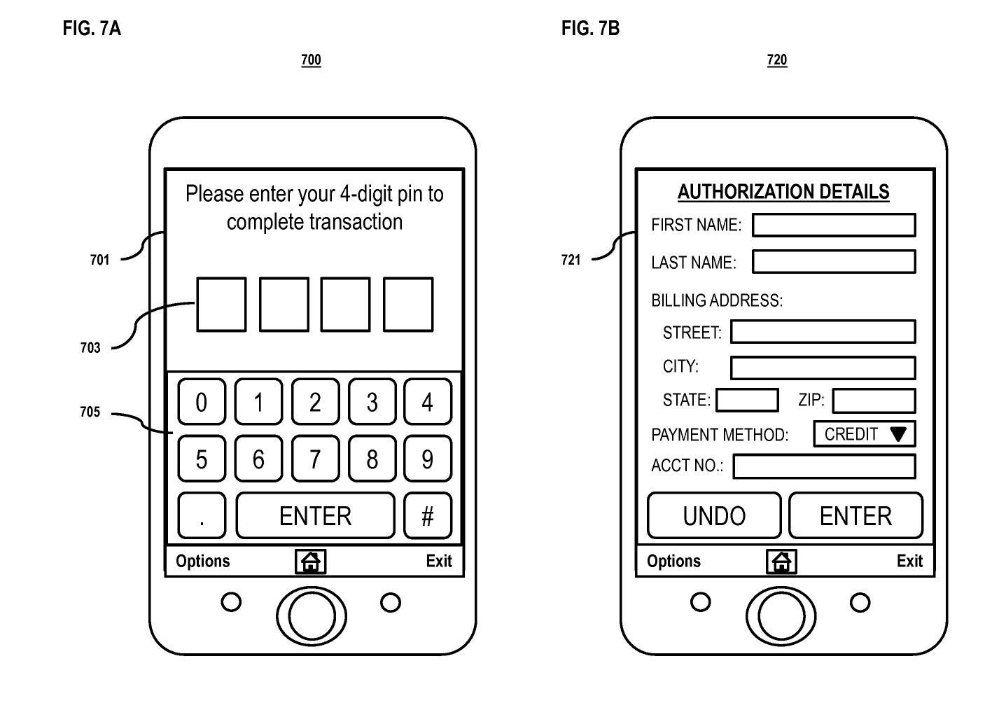

FIG. 6 is a diagram of the interaction between a wireless communication device and a point-of-sales terminal to facilitate a purchase transaction through use of a barcode image and a transaction verification process, in accordance with an exemplary embodiment. By way of example, transaction module 211 triggers a PIN or security code entry process, wherein the user of device 101 is required to provide the appropriate security code and payment authorization details via a user interface of device 101 to engage a purchase transaction, as shown with respect to FIGS. 7A and 7B.

Steps 601-611 of interactive process 600 resemble steps 501-511 of process 500 of FIG. 5. Process 600 further includes actions performed in conjunction with transaction module 211 of device 101. In step 613, process 600 provides for an automated or user prompted procedure wherein the message conveying the transaction details information is consumed/assimilated by transaction module 211. As such, pertinent information pertaining to the transaction is extracted from the transaction alert message, so as to generate an itemized goods and/or services list, cross reference the purchase amount against account records (credit card or bank account balances), or perform other tasks. This process may be triggered upon receipt of a transaction alert message or enabled by way of user push-button activation or the like. Once the message is consumed/assimilated, transaction module 611 further operates in connection with user interface module 205 to cause presentment of a PIN or security code entry screen to the display of wireless communication device 101. Accordingly, transaction module 211 requests from the user the PIN or security code corresponding to the credit card, debit card, prepaid card or other like payment medium (step 615).

The code request can be presented according to an exemplary graphical user interface (GUI) 700 of the device 101 is shown in FIG. 7A. In this example, a code entry screen 701 provides text boxes 703 for entry of numeric or alphanumeric characters by the user. In addition, the interface 700 may feature a data entry means in the form of a soft keypad 705 that the user may engage via touch screen technology. Alternatively, a hard keypad, button or other means may be used to permit code entry.

Return to process 600 of FIG. 6, once the PIN is submitted (e.g., by pressing the ENTER button) as in step 617, the process 600 requests payment authorization details, per step 619. FIG. 7B provides an exemplary interface 720 for collecting such authorization information. Interface 720 can be invoked by transaction module 211 in conjunction with user interface module 205. As shown, screen 721 displays fields for receiving authorization details, including information corresponding to but not limited to, the following: user name, billing address, method of payment (e.g., credit or debit card), account numbers, etc. It is noted that certain of the fields may be pre-populated pursuant to the message consumption/assimilation process of step 613. The user enters the details, which are then submitted to transaction module 211 (e.g., by pressing or otherwise activating the ENTER button), as in step 621. In step 623, the payment authorization data is then provided to the POS terminal 107, indicating acknowledgement of the purchase transaction by the user. Resultantly, the data is further processed (compared, validated, etc. against account records) by the payment services provider 111 to proceed with and/or signify completion of the purchase transaction.

The above described processes, in certain embodiments, advantageously provide an efficient, convenient, and secure approach for conducting financial transactions.

The processes described herein for providing mobile payment through a device user interface may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

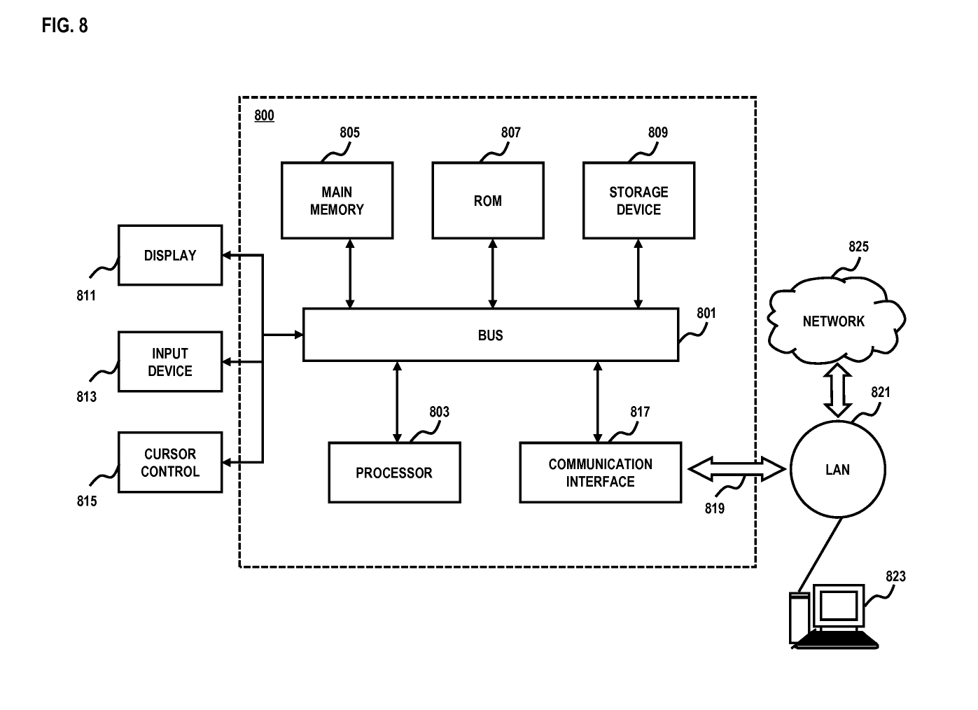

FIG. 8 illustrates computing hardware (e.g., computer system) upon which these embodiments can be implemented. The computer system 800 includes a bus 801 or other communication mechanism for communicating information and a processor 803 coupled to the bus 801 for processing information. The computer system 800 also includes main memory 805, such as random access memory (RAM) or other dynamic storage device, coupled to the bus 801 for storing information and instructions (computer program code) to be executed by the processor 803. Main memory 805 also can be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for controlling cursor movement on the display 811.

According to certain embodiments, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Model (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIG. 6, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

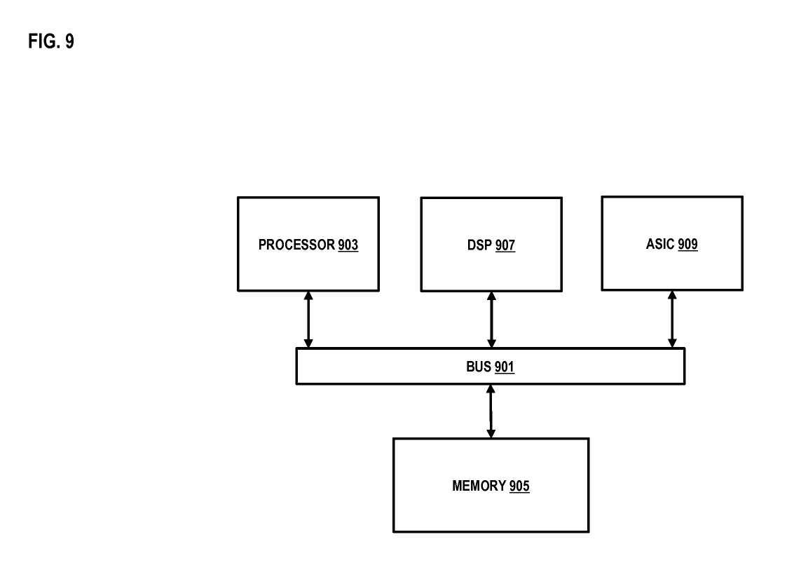

FIG. 9 illustrates a chip set 900 upon which an embodiment of the invention may be implemented. Chip set 900 is programmed to present a slideshow as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of FIGS. 4-6.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 905 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving barcode information at a point-of-sales terminal, wherein the barcode information is obtained from a barcode image acquired from a wireless communication device, the barcode image corresponding to a transaction between the wireless communication device and the point-of-sales terminal; and
generating a message in response to the received barcode information for transmission to the wireless communication device to permit acknowledgement of the transaction by a user of the wireless communication device.

2. A method according to claim 1, further comprising:
generating a notification message for transmission to the point-of-sales terminal in response to the acknowledgement of the transaction by the user.

3. A method according to claim 1, wherein the wireless communication device includes a cellular phone, the method further comprising:
transmitting the message using a short messaging service (SMS) to the wireless communication device; and
receiving an acknowledgement message from the wireless communication device in response to the SMS message.

4. A method according to claim 3, further comprising:
initiating a payment activity corresponding to the transaction in response to the received acknowledgement message.

5. A method according to claim 1, further comprising:
generating a control signal to the wireless communication device to activate an application on the wireless communication device, wherein the application prompts the user to enter a code to acknowledge the transaction.

6. An apparatus comprising:
at least one processor; and
at least one memory including computer program code, the at least one memory and the computer program code being configured to, with the at least one processor, cause the apparatus at least to:
receive barcode information from a point-of-sales terminal, wherein the barcode information is obtained from a barcode image acquired from a wireless communication device, the barcode image corresponding to a transaction between the wireless communication device and the point-of-sales terminal, and
generate a message in response to the received barcode information for transmission to the wireless communication device to permit acknowledgement of the transaction by a user of the wireless communication device.

7. An apparatus according to claim 6, wherein the apparatus is further caused to:
generate a notification message for transmission to the point-of-sales terminal in response to the acknowledgement of the transaction by the user.

8. An apparatus according to claim 6, wherein the wireless communication device includes a cellular phone, and the apparatus is further caused to:
transmit the message using a short messaging service (SMS) to the wireless communication device; and
receive an acknowledgement message from the wireless communication device in response to the SMS message.

9. An apparatus according to claim 8, wherein the apparatus is further caused to:
initiate a payment activity corresponding to the transaction in response to the received acknowledgement message.

10. An apparatus according to claim 6, wherein the apparatus is further caused to:
generate a control signal to the wireless communication device to activate an application on the wireless communication device, wherein the application prompts the user to enter a code to acknowledge the transaction.

11. A method comprising:
initiating presentation of a barcode image, by a wireless communication device, to a point-of-sales terminal as part of a payment transaction; and
receiving a message, over a wireless network, in response to the presentation of the barcode image, wherein the message requests acknowledgement of the transaction by a user of the wireless communication device.

12. A method according to claim 11, wherein the wireless network is a cellular network, and the message is a short messaging service (SMS).

13. A method according to claim 12, further comprising:
generating a reply message, by the wireless communication device, to acknowledge the transaction in response to the received SMS message.

14. A method according to claim 11, further comprising:
generating, in response to the received message, a prompt for presentation via a graphical user interface for the user to enter a code to acknowledge the transaction.

15. A method according to claim 11, further comprising:
processing the received message to determine that the message relates to the transaction; and
generating, in response to the processed message, a prompt for presentation via a graphical user interface for the user to enter a code to acknowledge the transaction.

16. An apparatus comprising:
at least one processor; and
at least one memory including computer program code, the at least one memory and the computer program code being configured to, with the at least one processor, cause the apparatus at least to:
initiate presentation of a barcode image, by a wireless communication device, to a point-of-sales terminal as part of a payment transaction, and
receive a message, over a wireless network, in response to the presentation of the barcode image, wherein the message requests acknowledgement of the transaction by a user of the wireless communication device.

17. An apparatus according to claim 16, wherein the wireless network is a cellular network, and the message is a short messaging service (SMS).

18. An apparatus according to claim 17, wherein the apparatus is further caused to:
generate a reply message, by the wireless communication device, to acknowledge the transaction in response to the received SMS message.

19. An apparatus according to claim 16, wherein the apparatus is further caused to:
generate, in response to the received message, a prompt for presentation via a graphical user interface for the user to enter a code to acknowledge the transaction.

20. An apparatus according to claim 16, wherein the apparatus is further caused to:
process the received message to determine that the message relates to the transaction; and
generate, in response to the processed message, a prompt for presentation via a graphical user interface for the user to enter a code to acknowledge the transaction.
